(19) United States
(12) Patent Application Publication
(10) Pub. No.: US 2007/0204223 A1
(43) Pub. Date: Aug. 30, 2007

(54) Methods of and systems for personalizing and publishing online content

(76) Inventors: Jay Bartels, Woodside, CA (US); Keith Cotterill, Menlo Park, CA (US); Andrew E. Davidson, Santa Cruz, CA (US)

Correspondence Address: HAVERSTOCK & OWENS LLP, 162 NORTH WOLFE ROAD, SUNNYVALE, CA, 94086, US

(21) Appl. No.: 11/710,075

(22) Filed: Feb. 23, 2007

Related U.S. Application Data
(60) Provisional application No. 60/777,585, filed on Feb. 27, 2006.
(60) Provisional application No. 60/838,613, filed on Aug. 17, 2006.

(51) Int. Cl. G06F 17/00; H04N 7/16

(52) U.S. Cl. 715/540; 715/530; 715/500.1; 725/25

(57) ABSTRACT

Embodiments of the present invention allow a user to replace unwanted content, such as advertisements, in data distributed over a network with wanted content. Data include Web pages, Internet television broadcasts, Internet radio broadcasts, or any other kind of data that contains content. The data, such as a Web page, is ultimately presented on the user's system, presenting the user with the wanted content. Wanted content includes, among other things, personal photographs, advertisements that the user has expressed interest in, and even advertisements for which the user is compensated for viewing or listening to. In accordance with the present invention, a user opts in to a system that replaces unwanted content with wanted content. The user opts in by providing information that helps determine (a) what content he does not want to see and thus will likely ignore if presented to him and (b) what content he would likely find interesting and thus likely view. This information includes URLs for Web sites; personal information, such as age, income, hobbies, and vacation plans; and work information, such as salary and job title.

### RELATED APPLICATIONS

This application claims priority under 35 U.S.C. § 119(e) of the co-pending U.S. Provisional Patent Applications, Ser. No. 60/777,585, filed Feb. 27, 2006, and titled “A Method and Apparatus for Direct Marketing to Consumers Using a Computer Network or Other Communication Technology,” and Ser. No. 60/838,613, filed Aug. 17, 2006, and titled “A Method and Apparatus for Personalizing and Publishing Online,” both of which are incorporated herein by reference.

### FIELD OF THE INVENTION

This invention relates to online content. More particularly, this invention relates to replacing content in data such as Web pages and Internet broadcasts with other content, using user-selected information.

### BACKGROUND OF THE INVENTION

Users navigating the Web are confronted with a never-ending stream of advertisements. Many Web pages that contain interesting information also contain unwanted advertisements. In response to “nuisance” advertisements, many users have changed their viewing habits. They either completely ignore all of the ads presented to them or they use tools such as Adblock^{SM} and Privoxy™ to block all ads, banners, and pop-ups. In either case, because the ads are ignored or not even seen, they cannot help to increase the sales they were intended to generate.

When ads are ignored, content providers, such as search engine owners (SEOs), lose money. Many of the content providers are paid by the number of users that click through to an advertiser's site. When ads are ignored or removed entirely, revenue generated by click-through rates fall.

Even when content providers are successful in displaying advertisements to viewers, they do not always present users with ads that are of any interest to the viewers. For example, some search engines collect search terms from a user to help match a user with ads that may be of interest to the user. This matching is often inaccurate. Moreover, advertisers do not know who has viewed the ad and thus have no way of contacting the viewers to solicit sales or even feedback. And because the identity of a user is not known, it cannot be determined whether an actual user or a script clicked through to an advertiser's site. Advertisers that pay content providers based on a click-through rate are thus vulnerable to click fraud.

Individual users are also vulnerable to abuses from content providers. For example, some content providers use Web bugs, contained in downloaded Web pages and stored on a user's computer, to surreptitiously monitor key strokes a user has entered and Web sites he has visited. This information can be used to determine a user's viewing habits, and thus what ads may be of interest to him. Web bugs are capable of collecting all kinds of sensitive information.

Indeed, many users are vulnerable to many kinds of mal-ware, including spy-ware and ad-ware, to name only a few.

Even using many of the available Web tools, the user has no direct control over the content that he sees. And short of blocking all ads, some of which he may want to view, he has no control over whether anyone monitors the keystrokes that he enters or the sites that he visits.

### SUMMARY OF THE INVENTION

Embodiments of the present invention replace unwanted content in documents, such as nuisance advertisements or objectionable material in Web pages, with wanted content ultimately displayed on a user host. Preferably, the content is determined from user-supplied information. In this way, users view only content that they had a hand in selecting. Advertisements and other content are thus narrowly tailored or “personalized” to match the user's interests.

In a first aspect of the present invention, a method of replacing content in data distributed over a network includes parsing the data for unwanted content and replacing the unwanted content with wanted content. Data include Web pages, Internet television programs, Internet audio programs, and other data distributed over a network or other medium.

In one embodiment, the data include an Internet television broadcast, and the method includes playing the Internet television broadcast, including the wanted content, on a user host. In another embodiment, the data include an Internet audio broadcast, and the method also includes playing the Internet audio broadcast, with the wanted content, on a user host. In still another embodiment, the data include a Web page, and the method also includes displaying the Web page with the wanted content on a user host.

The unwanted content, the wanted content, or both are determined from user input, such as personal information (e.g., upcoming vacation plans, a user's income, a user's hobbies) or work-related information (e.g., a user's job title). The wanted content includes a Web feed, a file, or both. In one embodiment, the wanted content is identified by an identifier for a file, such as a Uniform Resource Identifier (URI) or a pathname. Preferably, the URI is a Uniform Resource Locator (URL). The file includes an image file, an audio file, a video file an audio-video file, an executable file, or any combination of these. The unwanted content includes a Web feed, a file, or both.

Preferably, the method also includes providing a toolbar on a Web browser. The toolbar is configured to control replacing the unwanted content with the wanted content. The method also includes displaying a Web page containing the wanted content on a user host.

In one embodiment, the data is parsed on the user host. Alternatively, the data is parsed on a server or other host different from the user host.

In a second aspect of the present invention, a method of compensating a user for presenting content on a user host includes replacing unwanted content in data distributed over a network with wanted content based on user-selected information; presenting the data containing the wanted content on the user host; and compensating the user based on compensation criteria related to the wanted content. Data include, but are not limited to, Web pages, Internet television broadcasts, and Internet audio broadcasts. Preferably, the compensation criteria is a price that advertisers have bid to have their content presented to a user.

The method also includes providing a toolbar on a Web browser for controlling replacing the unwanted content with the wanted content. The content includes advertisements, and the method also includes collecting the user-selected information.

The wanted content includes a Web feed, a file, an identifier for a file, or any combination of these. The file is an image file, an audio file, a video file, an audio-video file, or an executable file. The method also includes registering the user to thereby associate the user with the wanted content.

In a third aspect of the present invention, a Web browser includes a presentation module for controlling replacing unwanted content in a displayed Web page with wanted content based on user-selected information. The presentation module includes a toolbar for controlling replacing the unwanted content with the wanted content.

Preferably, the presentation module includes a parser and a formatter. The parser is programmed to parse a Web page containing original content and identify unwanted content within the original content. The formatter is programmed to format the Web page to display the wanted content but not the unwanted content. The Web browser also includes a first rules file for determining unwanted content and a second rules file for determining wanted content. As used herein, the term “programmed” means to configure using software, hardware, firmware, other means, or any combination of these.

In another embodiment, the Web browser is programmed to communicate with a server, which is programmed to format the Web page to display the wanted content but not the unwanted content. The server includes a first rules file for determining unwanted content and a second rules file for determining wanted content. The wanted content includes a Web feed, a file, an identifier for a file (e.g., a URL), or any combination of these.

In a fourth aspect of the present invention, a presentation module includes means for identifying unwanted content for presented with data distributed over a network, means for associating wanted content for presenting with the data based on user-selected information, and means for presenting the data with the wanted content in place of the unwanted content.

The means for associating is programmed to format the data to contain an identifier, such as a URL, for accessing the wanted content. Data include Web pages, Internet television broadcasts, and Internet audio broadcasts, to name a few examples. Preferably, the presentation forms part of an electronic device for presenting the data, such as a personal computer, a mobile phone, a personal digital assistant, an Internet radio, or any other device configured to present data to a user.

In a fifth aspect of the present invention, a system for replacing unwanted content in data distributed over a network with wanted content includes a host coupled to a server. The host is programmed to control replacing the unwanted content in the data with the wanted content. The server is programmed to determine rules for identifying unwanted content and wanted content and to transmit the rules to the host.

Preferably, the host is programmed to display a toolbar for controlling replacing the unwanted content with the wanted content. In one embodiment, the data include a Web page and the toolbar forms part of a Web browser. In other embodiments, the data include an Internet television broadcast or an Internet audio (e.g., radio) broadcast.

In one embodiment, the host is programmed to replace the unwanted content with the wanted content. Alternatively, the server is programmed to replace the unwanted content with the wanted content.

In a sixth aspect of the present invention, a method of matching a user with an item, such as a commercial product or service, includes storing data generated from user input. The data include a record that associates a user with wanted Web content, unwanted Web content, or both. The method also includes matching the record against information corresponding to the item. In this way, an advertiser is able to search a database using product search terms, which are matched against user data to determine what products and services the user would likely be interested in. The user is then able to be targeted for promotional materials such as coupons, requests for feedback, and the like.

The method also includes transmitting content identifying the item to an address associated with the user. In one embodiment, the address is an electronic mail address and the content identifying the item is promotional material for the item. In another embodiment, the address is an Internet Protocol (IP) address and the content identifying the item is a Web object. In this other embodiment, transmitting the content identifying the item includes transmitting a Web page containing the Web object to the IP address.

Preferably, the information corresponding to the item includes a name of the item, a description of the item, or a specification of the item. As one example, product names, descriptions, or specifications are used to search a database to determine users who would likely be interested in a product or service.

In a seventh aspect of the present invention, a data processing system includes a database coupled to a search engine. The database stores one or more entries, each of which contains data that is generated from user input and that identifies Web content as either wanted content or unwanted content. The search engine is programmed to match the one or more entries against information corresponding to an item (e.g., a product or a service), thereby matching a user with the item.

### BRIEF DESCRIPTION OF THE DRAWINGS

FIG. 1 shows a Web page in the prior art, containing advertisements.

FIG. 2 shows the Web page of FIG. 1, in which the advertisements are replaced with wanted content, in accordance with the present invention.

FIG. 3 shows the steps of a process for replacing unwanted content with wanted content, in accordance with the present invention.

FIG. 4A shows a portion of the Web page in FIG. 1 in HyperText Markup Language.

FIG. 4B shows a portion of the Web page in FIG. 2 in HyperText Markup Language, in accordance with the present invention.

FIG. 5A shows a table corresponding to a rules file for determining unwanted content in accordance with the present invention.

FIG. 5B shows an extensible Markup Language file corresponding to the table in FIG. 5A.

FIG. 6 shows the steps of a process for determining unwanted content using information other than metadata, in accordance with one embodiment of the present invention.

FIG. 7 shows a table containing a list of URLs to wanted content, in accordance with the present invention.

FIG. 8A shows an album from which a user is able to select wanted content in accordance with the present invention.

FIG. 8B shows an extensible markup Language file containing the links to the entries in the album of FIG. 8A.

FIG. 9 shows a table corresponding to a rules file containing bids from advertisers, used to determine substitute content from among multiple wanted content.

FIG. 10 shows steps for determining substituted content from a pool of wanted content, in accordance with the present invention.

FIG. 11 shows the components of a system for replacing unwanted content with wanted content in a Web page, in accordance with the present invention.

FIG. 12A shows a graphical user interface for collecting information for generating rules files for determining wanted and unwanted content in accordance with the present invention.

FIG. 12B shows a graphical user interface for entering URLs corresponding to unwanted and wanted content, in accordance with the present invention.

FIG. 13 shows an extensible Markup Language file containing a user profile, in accordance with the present invention.

FIG. 14 shows an Internet television program with a wanted advertisement replacing an unwanted advertisement, in accordance with the present invention.

FIG. 15A shows a data packet for an Internet broadcast containing a first sub packet with data and a second sub packet with unwanted content.

FIG. 15B shows a third sub packet with wanted content, selected in accordance with the present invention, for replacing the second sub packet in FIG. 15A.

### DETAILED DESCRIPTION OF A PREFERRED EMBODIMENT

The present invention gives a user control over what content is displayed within or along with data downloaded to his system, data that he ultimately views. A system in accordance with the present invention allows a user to opt in to a service that collects information about or associated with him. This information can be used to determine what advertisements or other content the user does not want to view (“replaceable” or “unwanted” content) and advertisements or other content that the user does want to view (“wanted” content). The data include Web pages, Internet television broadcasts, Internet audio broadcasts, or any other type of data that is presented to a user.

Embodiments of the present invention thus ensure that a user receives and is thus presented with only wanted content. This wanted content can be digital photographs of the user's family, advertisements related to a trip that the user is planning, Web feeds for stocks that the user owns, and the like. The user can also ensure that Web bugs and other unwanted scripts, cookies, and malicious data are never downloaded onto his computer.

By opting in to the service, the user can also be compensated for viewing advertisements. For example, in exchange for his personal or work-related information, an advertiser agrees to compensate the user with money, credits for goods or services, coupons, and the like, whenever a user is presented with an ad from the advertiser. In a preferred embodiment, the system determines when a user views an advertisement by identifying a user's toolbar and associating the toolbar with a Web page containing the advertisement that the user visits. In other embodiments, advertisers identify a user visiting its site using cookies installed on a user host, source Internet Protocol addresses, and other means known to those skilled in the art.

Also, when a user opts in to the service, information about him is stored so that advertisers are able to match him with products or services he would likely be interested in. Advertisers are thus able to target advertisements, promotions, and other materials to the user.

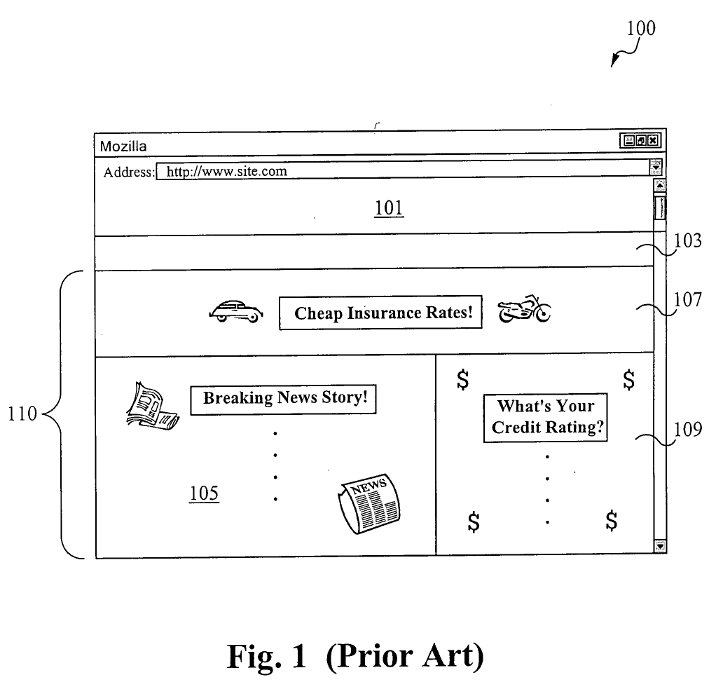

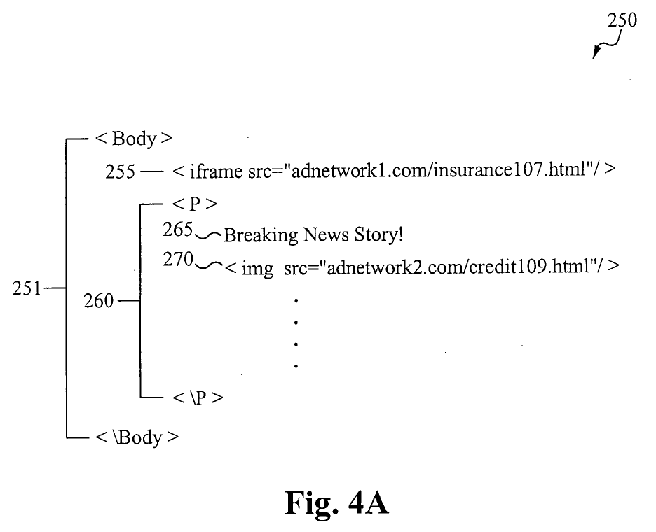

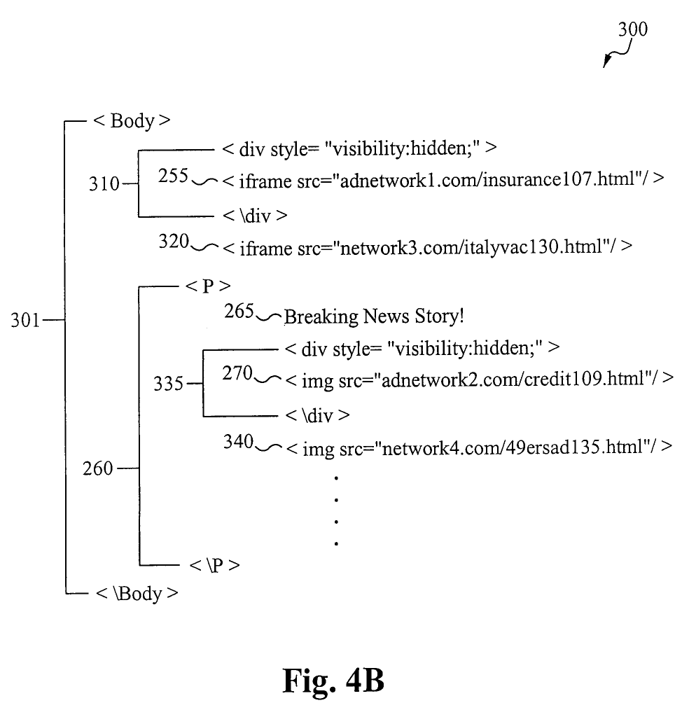

As a first example, content in a Web page is replaced. FIG. 1 is a Web page 100 in the prior art. The Web page 100 contains a panel 101 showing the Web address of the Web page (“www.site.com”), a toolbar 103, and original content 110 that includes text 105 and advertisements 107 and 109. The Web page 100 is written in HyperText Markup Language (HTML) and contains Uniform Resource Locators (URLs) of the advertisements 107 and 109 (see FIG. 4A). In operation, when a Web browser loads the Web page 100, it uses the URLs of the advertisements 107 and 109 to fetch the advertisements 107 and 109 from an advertiser's Web site. The advertisements 107 and 109 are then combined with the text 105 to form the original content 110 rendered on a computer display screen. To most people, the advertisements 107 and 109 are unwanted content, advertisements about insurance rates (107) and credit ratings (109).

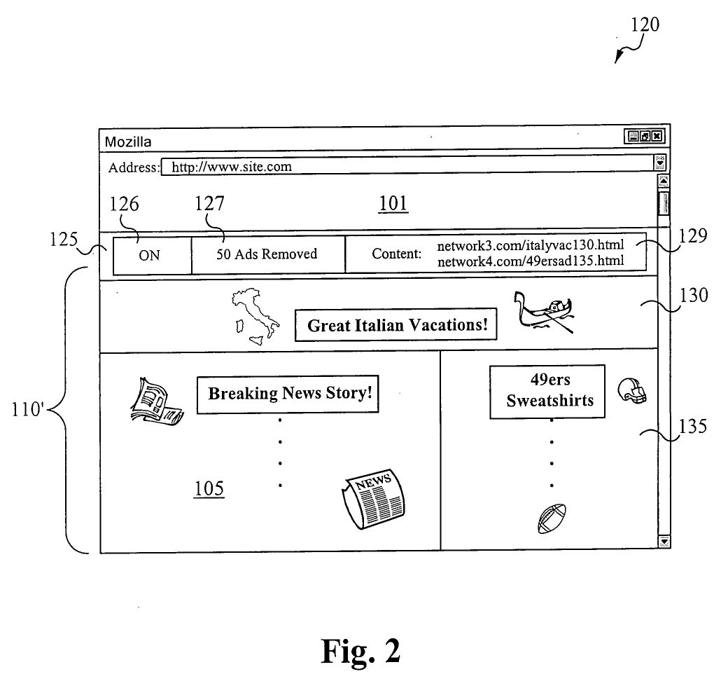

FIG. 2 is a Web page 120 in accordance with the present invention, loaded from the same Web address, www.site.com, as the Web page 100. In the Web page 120, however, the content 130 and 135 (wanted content) has replaced the advertisements 107 and 109 (unwanted content) shown in FIG. 1. The content 105, 130, and 135 is labeled 110′. In accordance with the present invention, a user now has control over selecting the content 130 and 135. As only a few examples, the content 130 and 135, derived from information selected by the user, includes:
digital images stored on a user's host computer
digital images stored on a Web server, which can be constantly updated, so that each time a Web page from the Web server is loaded the user sees updated digital images
advertisements selected by the user
advertisements from an advertiser selected by the user
a Web feed, such as one using Real Simple Syndication (RSS), generating news reports
a Web feed displaying stock quotes
content selected by comparing user-selected information (e.g., vacation plans) with content offered by advertisers
a display showing subject lines of unread email
a display showing a log of missed phone calls
a display of a to-do-list

While FIG. 2 shows a Web page rendered using the Mozilla™ Web browser, it will be appreciated that any other Web browser can be used in accordance with the present invention.

Still referring to FIG. 2, the Web page 120 includes a toolbar 125. The toolbar 125 includes an ON/OFF button 126, an “Ads removed” icon 127 showing how many advertisements have been replaced, and a “Content” label field 129 showing URLs of the wanted content 130 and 135 (FIG. 4B). The ON/OFF button 126 is used to enable and disable replacing content in accordance with the present invention. When the ON/OFF button 126 is toggled ON, content is replaced; when OFF, content is left undisturbed. In one embodiment, the Content label field 129 is a drop-down menu for selecting wanted content.

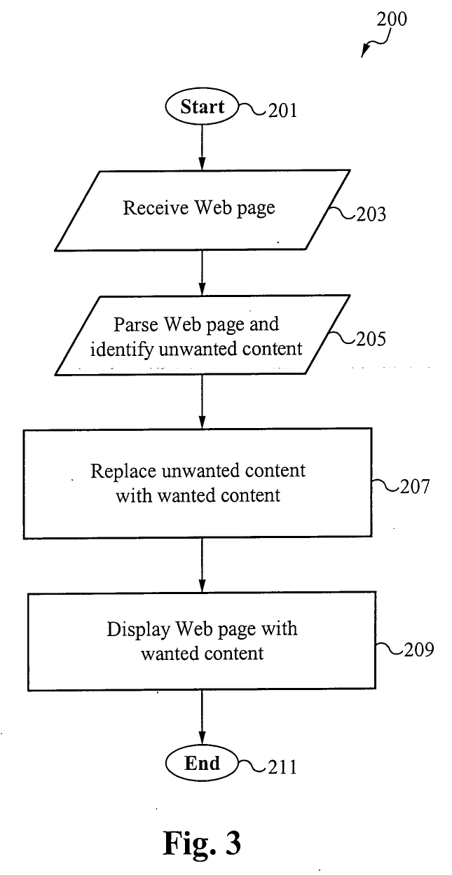

FIG. 3 shows the steps of a process 200 for replacing unwanted content with wanted content in accordance with one embodiment of the present invention. Referring to FIG. 3, the process starts in the start step 201, in which, among other things, any parameters are initialized. Next, in the step 203, a Web page (e.g., 100, FIG. 1) is received and, in the step 205, the Web page is parsed for unwanted content (e.g., 107 and 109, FIG. 1), which is identified, as described below. Next, in the step 207, the unwanted content is replaced with wanted content (e.g., 130 and 135, FIG. 2). In the step 209, the Web page containing the wanted content (the “updated Web page”) is displayed, and the process ends in the step 211.

As described in more detail below, preferably the unwanted content and the wanted content are identified by rules. For example, a user inputs into a first rules file a list of the URLs associated with unwanted content, such as the domain “insurance.com.” That is, any Web page with an address that includes the domain “insurance.com” is identified as unwanted content. Similarly, a user is able to input into a second rules file a list of URLs associated with wanted content, that is, URLs associated with sites from which he wants to receive advertisements or other content (e.g., “sports.com”). The second rules file can also include paths to images on a user computer, which the user would like to include as wanted content in accordance with the present invention. As explained below, there are many ways to determine wanted and unwanted content and many locations from which wanted content can be retrieved.

As explained below, in one embodiment of the invention, the unwanted content is “replaced” by formatting a Web page so that URLs to wanted content are visible in a Web page (thus allowing the wanted content to be displayed) but URLs to unwanted content are hidden. A toolbar, such as the toolbar 125 in FIG. 2 above, thus allows a user to toggle between (a) displaying the wanted content and hiding the unwanted content and (b) displaying the unwanted content and hiding the wanted content.

FIGS. 4A and 4B show, respectively, a portion of the content 110 in FIG. 1 as an HTML file 250 and a portion of the content 110′ in FIG. 2 as an HTML file 300. Referring to FIGS. 1 and 4A, the HTML file 250 contains a body tag pair 251; an iframe tag 255 containing a URL for the advertisement 107, “adnetwork1.com/insurance107.html”; a paragraph tag pair 260 that contains text 265 and an image tag 270 containing a URL for the advertisement 109, “adnetwork2.com/credit109.html.” Preferably, the HTML files 250 and 300 have associated Cascading Style Sheets (CSS), either embedded within them or included as separate files.

Elements in FIGS. 4A and 4B with the same label refer to the same elements. The URL of the advertisement (content) 130 is “network3.com/italyvac130.html,” the data in the element 320, and the URL of the advertisement (content) 135 is “network4.com/49ersad135.html” the data in the element 340. Referring to FIGS. 2 and 4B, the iframe element 255 and the image element 270 are “hidden” so that the advertisements 107 and 109 are not shown when the Web page 120 is displayed (FIG. 2); the iframe element 320 and the image element 340 are not hidden so that the content 130 and 135 are shown when the Web page 120 is displayed (FIG. 2). Referring to FIG. 4B, the iframe element 255 (and thus the content 107) is hidden by enclosing it within the DIV tag pair 310 and setting the associated visibility attribute to the value “hidden.” Similarly, the image element 270 (and thus the content 109) is hidden by enclosing it within the DIV tag pair 335 and also setting the associated visibility attribute to the value “hidden.”

Still referring to FIGS. 2 and 4B, the advertisements 130 and 135 in FIG. 2 are displayed in the Web page 120 by inserting the element 320 and 340 in the HTML file 300. The element 320 sets the src (“source”) attribute to the URL of the advertisement 130 (“network3.com/italyvac130.html”), and the element 340 sets its src attribute to the URL of the advertisement 135 (“network4.com/49ersad135.html”).

FIG. 4B shows the HTML of the Web page 120 when the ON/OFF button 126 (FIG. 2) is ON, so that content is replaced in accordance with the present invention. When the ON/OFF button 125 (FIG. 2) is OFF, the element 320 and 340 (and thus the advertisements 130 and 135) are hidden using DIV tags, and the elements 255 and 270 (and thus the advertisements 109 and 109) are no longer hidden. The Web page 100 in FIG. 1 will thus be displayed. In other words, the content 107 and 109 is not removed and can be displayed when the Web page 100 is reloaded. Thus, in one embodiment, DIV tags can be dynamically inserted, deleted, or moved to selectively display and hide content.

Those skilled in the art will appreciate that while the values of the src attributes in the elements 255, 270, 320, and 340 are all URLs, the values can be set to paths on a computer network, such as C:/pictures/grandma.html; paths to email folders; paths to a “missed phone-calls” log; or any other identifier to content. Thus, rather than view unwanted content in a Web page, a user is able to view pictures of her grandmother, subject lines of unread emails, and summaries of missed phone calls, to give only a few examples of content.

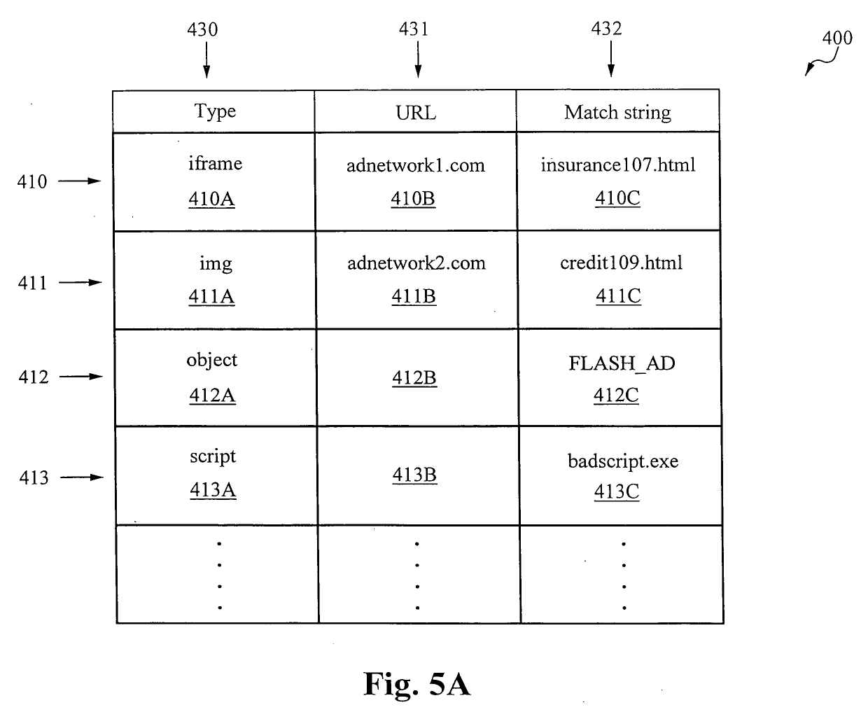

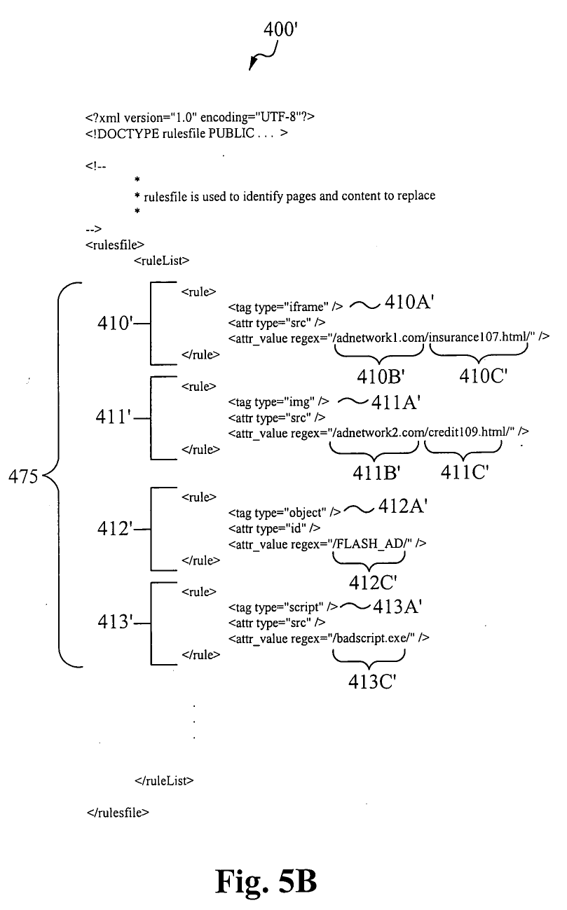

FIG. 5A shows a table 400 corresponding to a rules file used to determine unwanted content, in accordance with the present invention. (In this and the other examples in this Specification, a table and its corresponding rules file are used interchangeably and labeled with the same number.) As explained below, the table 400 is used merely to explain how rules are implemented. Preferably, the information contained in the table 400 is formatted in a structure such as an extensible Markup Language (XML) file, such as discussed below.

The table 400 contains rows 410-413 and columns 430-432. Each of the rows 410-413 contains an entry (or record) defining a single rule that, if satisfied, identifies the content being analyzed (the candidate content) as unwanted. Each of the columns 430-432 contains elements of a rule. The column 430, labeled “Type,” indicates a type that candidate content must have to satisfy a rule; the column 431, labeled “URL,” indicates a URL that the candidate content's domain must match to satisfy the rule; and the column 432, labeled “Match string,” indicates a string that must be found in any portion of the URL to satisfy the rule. It will be appreciated that elements “URL” and “Match string” are able to be concatenated and considered a single element. All of the elements of a rule must be satisfied for candidate content to be considered unwanted.

Thus, referring to row 410 in FIG. 5A, if candidate content is of the type “iframe” (element 410A), has the domain URL “adnetwork1.com” (element 410B), and contains the string “insurance107.html” (element 410C) in its URL, then it is considered unwanted. Using the rule defined in the row 410, the content identified by the tag 255 in FIG. 4A is determined to be unwanted content.

Under the rule defined in the row 411 in FIG. 5A, content is determined to be unwanted if it is of the type “image” (element 411A), has as its domain the URL “adnetwork2.com” (element 411B), and contains the string “credit109.html” (element 411C) in its URL (e.g., “adnetwork2.com/credit109.html”). Using the rule defined in the row 411, the content identified by the tag 270 in FIG. 4A is determined to be unwanted content.

Similarly, the rule defined in the row 412 identifies content as unwanted if is the type “object” (element 412A), is hosted on any domain (indicated by the empty element 412B), and contains the string “FLASH_AD” in its URL (element 412C). In other words, any object from a URL containing the string “FLASH_AD” from any source is considered unwanted. Finally, the rule defined in the row 413 identifies content as unwanted if it is of type “script” (element 413A), is hosted on any domain (element 413B), and contains the string “badscript.exe” in its URL (element 413C). As illustrated by the elements 412B and 413B, an empty element is not considered when determining whether a rule is satisfied.

FIG. 5B shows an XML file 400′ corresponding to the table 400 in FIG. 5A. The XML file 400′ has “rule” elements 410′-413′. All of the primed elements (′) in FIG. 5B correspond to similarly numbered unprimed elements in FIG. 5A. Thus, the rule 410′ in FIG. 5B corresponds to the rule 410 in FIG. 5A; the rule 411′ in FIG. 5B corresponds to the rule 411 in FIG. 5A; the rule 412′ in FIG. 5B corresponds to the rule 412 in FIG. 5A; and the rule 413′ in FIG. 5B corresponds to the rule 413 in FIG. 5A.

Thus, referring to FIGS. 5B and 5A, the element 410A′ in FIG. 5B corresponds to the element 410A in FIG. 5A; the element 410B′ in FIG. 5B corresponds to the element 410B in FIG. 5A; and the element 410C′ in FIG. 5B corresponds to the element 410C in FIG. 5A. The elements 411′, 412′, and 413′ are similarly described and will not be discussed here.

While FIG. 5B shows the rules file 400′ as an XML file, it will be appreciated that the rules file 400′ can be in any other format and can also be any type of file, including a flat file or the combination of files in a relational database. As one example, rules files are contained in a document type definition (DTD) file or an XML schema file.

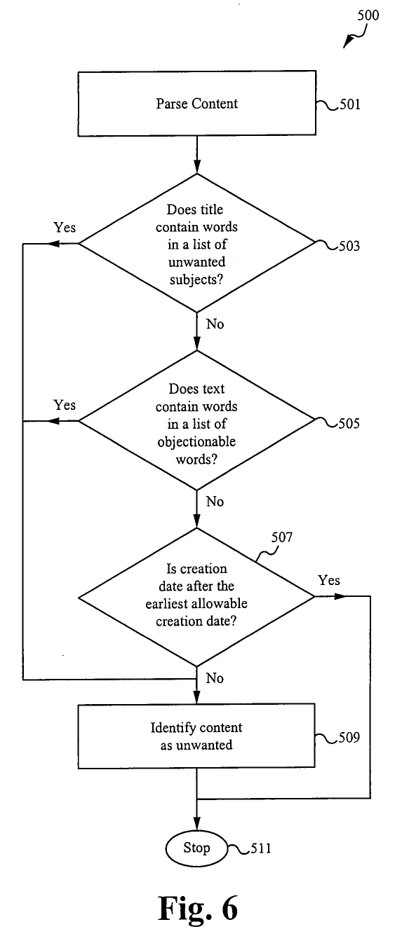

FIGS. 5A and 5B thus show how to determine whether content is unwanted by analyzing metadata about a Web object: its type, source, and path identifiers. Other embodiments of the invention determine whether content is unwanted using other criteria. In accordance with another embodiment, content (such as a Web object) is parsed and, if it is determined that the content is directed to subject matter than a user is not interested in, contains objectionable material, or was posted too long ago, then the content is considered unwanted. FIG. 6 shows the steps of a process 500 for determining whether content is unwanted, in accordance with one embodiment of the present invention.

The process 500 starts in the step 501, in which the content is parsed. Next, in the step 503, the process determines whether a title of the content contains words in a list of subjects that a user considers unwanted. As one example, if the content is an XML file, in this step the process parses the data within the “title” tags. If the content contains words in this list, the process continues to the step 509; otherwise, the process continues to the step 505.

In the step 505, the process determines whether text of the content (contained, for example, between “body” tags) contains words in a list of objectionable words, also unwanted content. If the text contains words in this list, the process continues to the step 509; otherwise, the process continues to the step 507. This step in the process can be used, for example, by parents, to ensure that advertisements and other content with objectionable language is not presented to their children.

In the step 507, the process determines whether the creation or posted date of the content (if available) is after a “latest allowable creation date,” determined by the user. If the content was created or posted after this latest allowable creation date, then the process continues to the step 511; otherwise the process continues to the step 509. This step allows users to prevent “stale advertisements,” such as advertisements for cruises long since completed, to be displayed. In the step 509, the process identifies the content as unwanted and then continues to the step 511, where it ends.

It will be appreciated that rules in accordance with the present invention are able to be combined in many ways. For example, by combining elements of the rules defined in FIGS. 5B and 6, content is considered unwanted if it is hosted on a site with the URL “site.com” and also contains the string “Galapagos Island Vacations” in its title.

In some embodiments of the present invention, rules files are also used to determine wanted content for replacing unwanted content, such as in Web pages. These rules files can be merely lists of URLs of Web content (implicit rules), lists of paths to content on a user's computer, and rules that select content based on how much advertisers bid to have users view their ads, to name only a few types of rules.

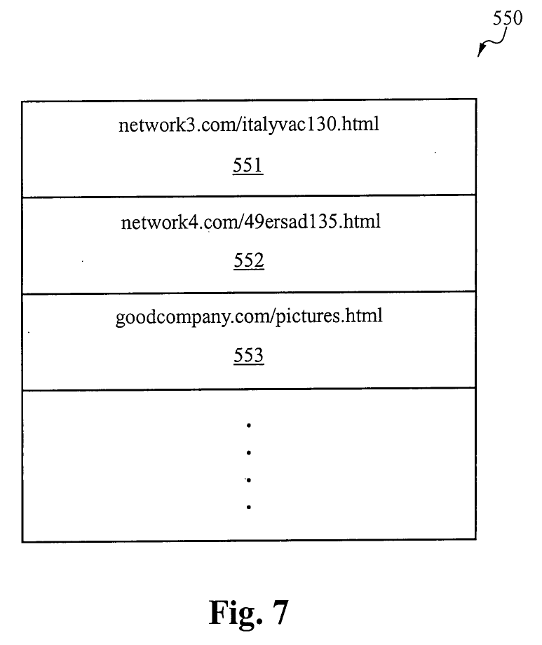

FIG. 7 shows a table 550 representing a rules file and containing entries of wanted content. The rules in the rules file 550 are “implicit” in that the rules are not stated within the rules file 550 itself but are implicit in the order of the entries. In FIG. 7, for example, the “rule” is that entries 551-553 of URLs to wanted content are selected sequentially. Referring to FIG. 7, the entry 551 in the first row indicates that the content with the URL “network3.com/italyvac130.html” (included in the element 320 in FIG. 4B) is wanted content. The entry 552 in the second row indicates that the content with the URL “network4.com/49ersad135.html” (included in the element 340 in FIG. 4B) is also wanted content. And the entry 553 in the third row indicates that the content with URL “goodcompany.com/pictures.html” is also wanted content. The list of entries 551-553 thus identifies a pool of wanted content.

In the operation of one embodiment, the first time unwanted content is to be replaced with wanted content, the content in the entry 551 is selected; the second time unwanted content is to be replaced, the content in the entry 552 is selected. Entries in the table 550 are thus selected sequentially. Or, if two blocks of unwanted content are to be replaced, the contents in the entries 551 and 552 are selected first; the second time two blocks are to be replaced, the contents in the next two entries are selected. Again, entries are selected sequentially, now two at a time. Alternatively, the entries 551-553 are selected in a round-robin fashion; or a predetermined entry (e.g., 551) is always selected until the user selects another “favorite” entry.

While FIG. 7 shows three entries 551-553, it will be appreciated that a list (pool) of wanted content can include a single entry or any number of entries.

It will be appreciated that many other rules are able to be used to determine wanted content. Preferably, the rules file 550, shown as a table in FIG. 7 for ease of illustration, is an XML file, but it can be in any other format known to those skilled in the art.

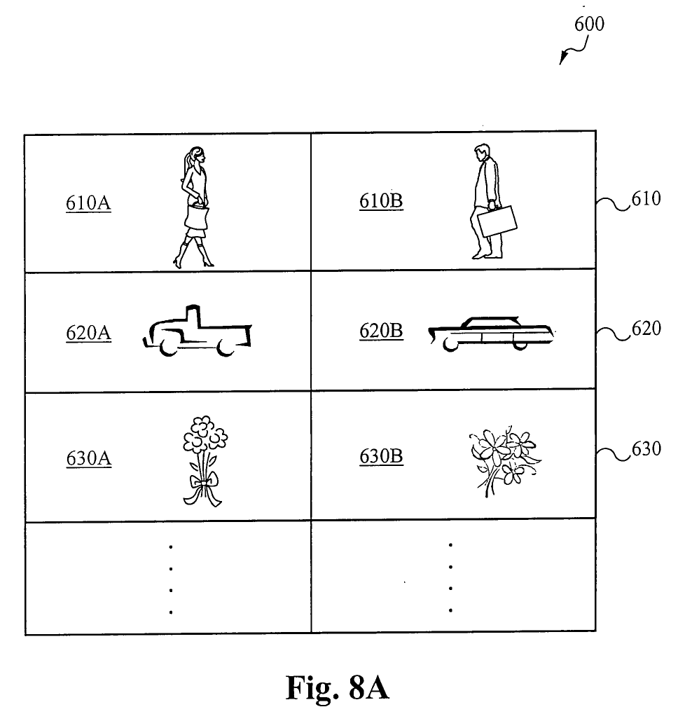

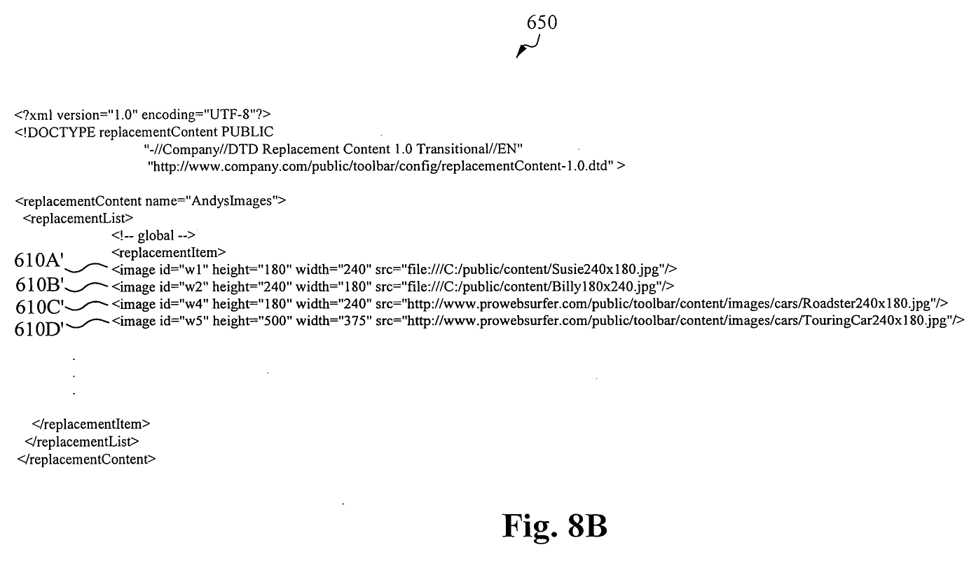

As explained above, wanted content can be of many different types, in addition to Web objects identified by URLs. As one example, wanted content is an image file stored on a user's computer and identified by a pathname, such as “C:/photos/grandma.” FIG. 8A shows an album 600 of candidate images 610A, 610B, 620A, 620B, 630A, and 630B (a pool of wanted content) that a user can select for display on his computer, to replace unwanted content.

In one example, referring to FIG. 4B, an image labeled “Susie” is located in the “content” folder on a user's C drive and shown as the image 610A. If the image is chosen as selected content, the element 320 is replaced with the element <image id=“w1” height=“180” width=“240a” src=“file:///C:/public/content.Susie240x180.jpg”/>.

FIG. 8B is an XML rules file 650 corresponding to the album 600 shown in FIG. 8A. Again, prime-numbered elements in FIG. 8B correspond to unprimed elements in FIG. 8A. In other words, the element 610A′ in FIG. 8B contains a path to the image 610A in FIG. 8A, and the element 610B′ in FIG. 8B contains a path to the image 610B in FIG. 8A.

As shown in FIG. 8B, the elements 610A′ and 610B′, both with their source attributes having the prefix “file:///C:”, refer to images stored on a user's host computer. The elements 610B′ and 610C′, both with their source attributes having the prefix “http://www.prowebsurfer.com,” refer to images stored on a remote computer and accessible using HyperText Transfer Protocol (HTTP). It will be appreciated that wanted content is able to be stored as images locally or remotely, and accessible using any number of protocols.

A user is able to have any number of albums from which she can select wanted content. Furthermore, the user is able to edit those albums, to add, delete, or modify images.

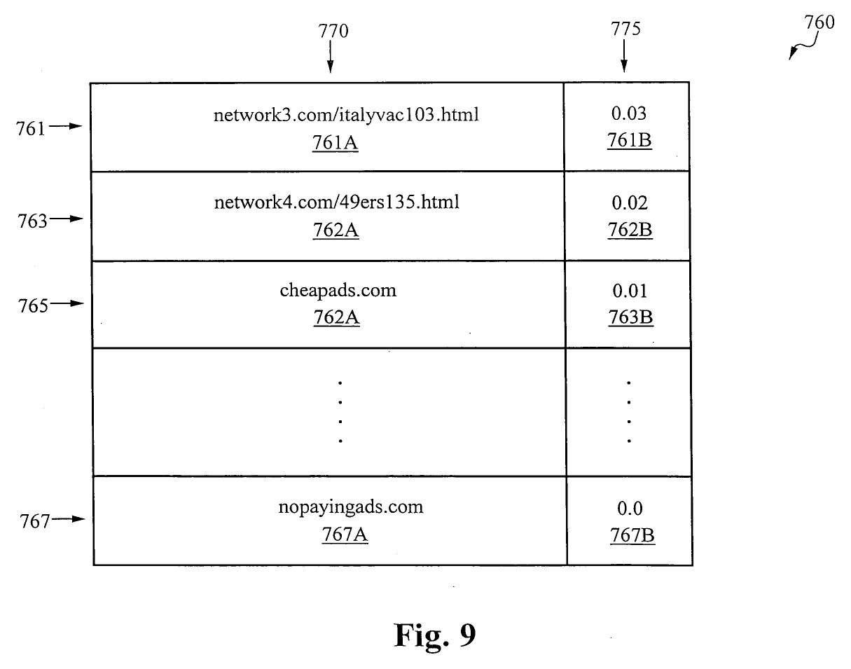

FIG. 9 shows a table 760 corresponding to a rules file for determining wanted content, based on bids that advertisers are willing to pay users to view an advertisement. The rules file 760 contains the rows 761, 763, 765, and 767, and the columns 770 and 775. The rows 761, 763, 765, and 767 contain entries for ads from advertisers. The columns 770 show, respectively, the URL for an ad and the price (bid) that the advertiser is willing to pay a user to view the corresponding ad, a content publisher to publish the ad, or both. Thus, for example, referring to the row 761, the “owner” of the ad at the URL “network3.com/italyvac130.html” (element 761A) will pay a user $0.03 (element 761B) to view the ad. The values in each of the rows 763, 765, and 767 are similarly explained. Thus, a user will earn more to view the ad at the URL in row 761 ($0.03, element 761B) than he will to view the ad at the URL in row 765 ($0.01, element 763B). Thus, when selecting wanted content, the content in the element 761A is selected over the content in the element 763A.

In accordance with the present invention, wanted content can be determined in many ways. For example, a user or an algorithm can generate a pool of wanted content, from which the wanted content is ultimately selected (“selected” or “replacement” content). As one example, a list of wanted content is generated using rules analogous to those shown in FIG. 6. In this example, content is determined to be wanted if its title contains predetermined text (e.g., “football jerseys”) analogous to the step 503 in FIG. 6, or if the body of the text contains predetermined text (e.g., “Super Bowl tickets”) analogous to the step 505 in FIG. 6.

In one embodiment, content is selected based on a measure of similarity between a URL of content that the user has identified as wanted content and a URL of advertiser's content. This embodiment is used, for example, when wanted content is not available (e.g., a server is down). As one example, a user has indicated that wanted content has the “wanted” URL “multiplesitehost.com/level1/level2,” but that content is unavailable. A first advertiser posts first content with a first URL “multiplesitehost.com/level1/product1” and a second advertiser posts second content with a second URL “multiplesitehost.com/levelA/product2.” In this example, the first URL matches the wanted URL up to “level1” and the second URL matches the wanted URL only up to “multiplesitehost.com.” In this example, the first URL is more similar (e.g., has a greater measure of similarity) to the wanted URL than the second URL is to the wanted URL. Accordingly, the content at the first URL is selected as wanted content.

The above examples illustrate how wanted content is selected from the pool of wanted content using selection criteria. For example, referring to FIG. 7, wanted content can be selected by its location in the file 550 (e.g., the entry 551 is first and, therefore, if the content is available, it is selected), using sequential selection (e.g., the entry 551 was selected and displayed most recently, so the entry 552 is selected and displayed next), or round robin. Using the rules file 760 shown in FIG. 9, selection is based on bids (e.g., the owner of the content listed in entry 761 pays a user more money to view the content in the entry 761 A than the owner of the content listed in entry 763 pays the viewer to view the content in the entry 763B). In still other embodiments, wanted content is selected based on a similarity between its URL and a URL that a user has indicated contains wanted content.

Rules, such as those described in the rules files 550 and 760, are able to be combined: For example, a pool of wanted content (“candidate” selected content) is chosen from the rules file 550 based on a first set of selection criteria, and then the final selection criteria takes into account the bids in the rules file 760. It will be appreciated that selection criteria can be based on any number and combination of rules.

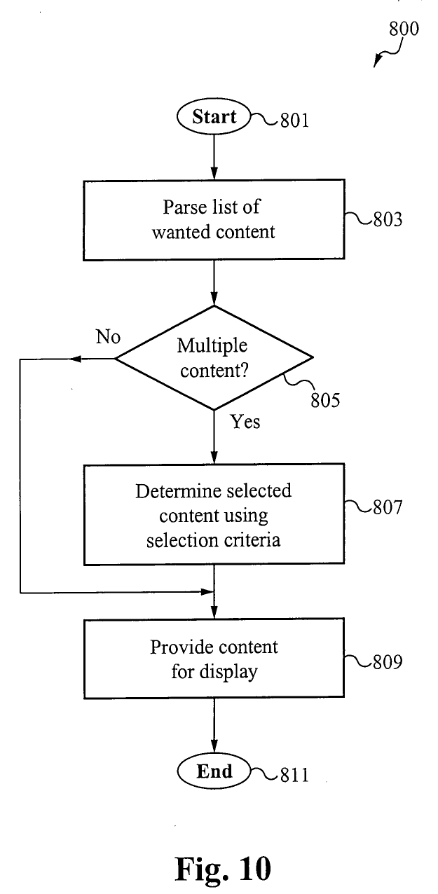

FIG. 10 shows the steps 800 of a process for selecting wanted content in accordance with one embodiment of the present invention. The steps 800 are performed as part of the step 207 in FIG. 3. Referring to FIG. 10, the process starts in the start step 801, in which parameters such as pointers into a rules file are initialized, advertiser bids are processed, etc. Next, in the step 803, the rules file (e.g., a list or pool of wanted content) is parsed, and in the step 805 the process determines whether there are multiple entries in the list. If there is only a single entry, the process continues to the step 809, in which the wanted content replaces the unwanted content, and the process ends in the step 811.

If, in the step 805, it is determined that multiple entries exist in the rules file, the process continues to the step 807 in which substituted content is selected from among the multiple entries using selection criteria, such as described above, and the process continues to the step 809.

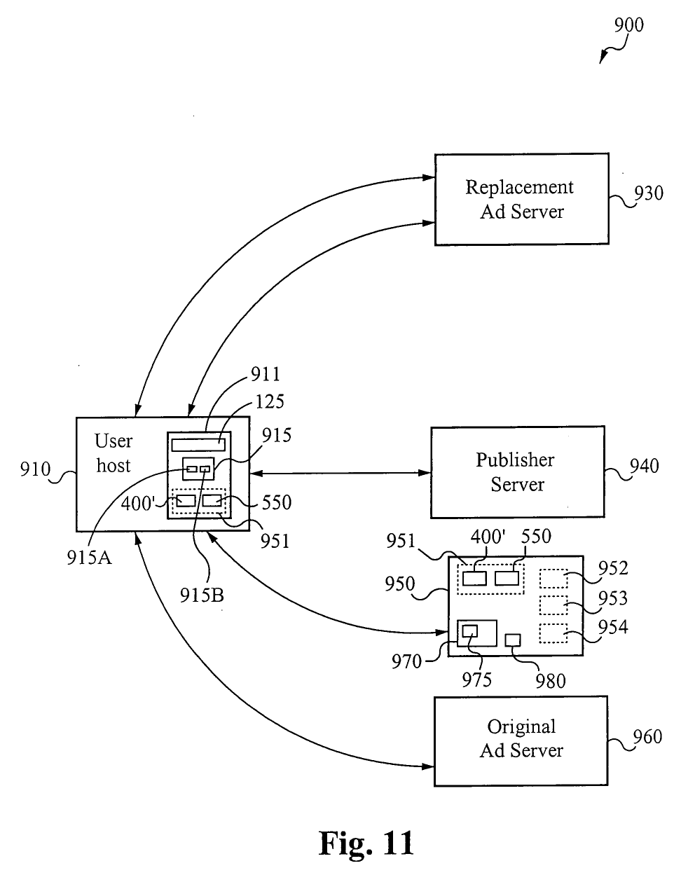

FIG. 11 is a block diagram of elements of one embodiment of the present invention and a system 900 of which they form a part. The system 900 includes a user host 910 coupled to a replacement ad server 930, a publisher server 940, a system server 950, and an original ad server 960. The user host 910 includes a Web browser 911, which includes the toolbar 125 (FIG. 2) and a presentation module 915. The presentation module 915 includes a parser 915A and a formatter 915B. In one embodiment, the toolbar 125 includes the presentation module 915.

The publisher server 940 stores original content Web pages (e.g., 110, FIG. 1), such as news articles (e.g., the element 105 in FIGS. 1 and 2). The original content also includes links (e.g., URLs) to unwanted content (e.g., the URLs in the elements 255 and 270 in FIG. 4B), embedded in the news articles. The replacement server 930 contains wanted content identified by URLs (e.g., the URLs in the elements 320 and 340 in FIG. 4B).

The system server 950 includes multiple sets 951-954 of rules files, one set for each user (e.g., user host) who has opted in to the system of the present invention. The set of rules file 951 includes the rules files 400′ and 550, shown in FIGS. 5B and 7, respectively. As shown in FIG. 11, the rules file 951 has been downloaded to the user host 910. Preferably, the user host 910 and the system server 950 periodically synchronize so that the rules files and other related data are updated so that both the user host 910 and the system server 950 have the most recently updated copy of a rules file.

The system server 950 also includes an interface 980 to a search engine coupled to a profile database 970. The profile database 970 stores profiles of users (e.g., stored as records) including a profile 975 of the user on the user host 910. User profiles in accordance with the present invention are described in more detail below.

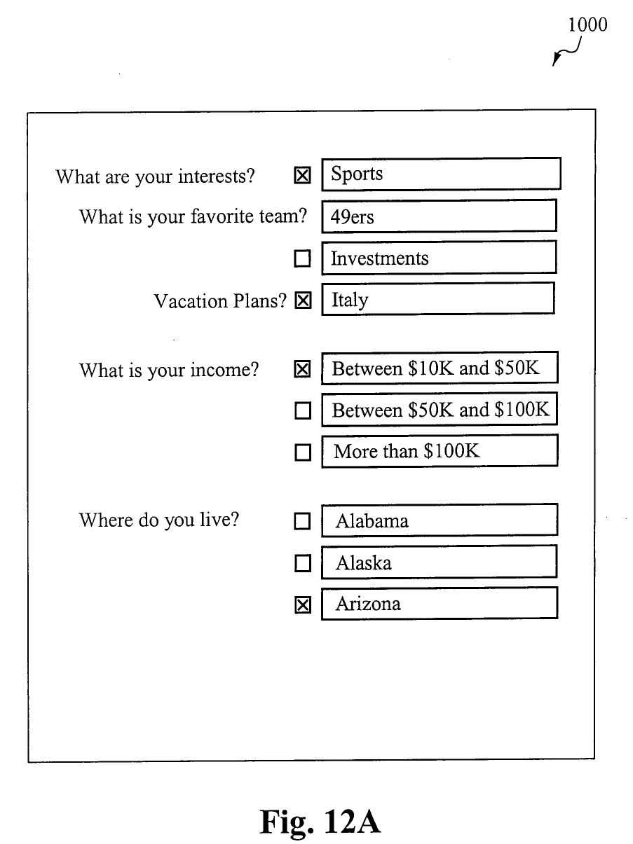

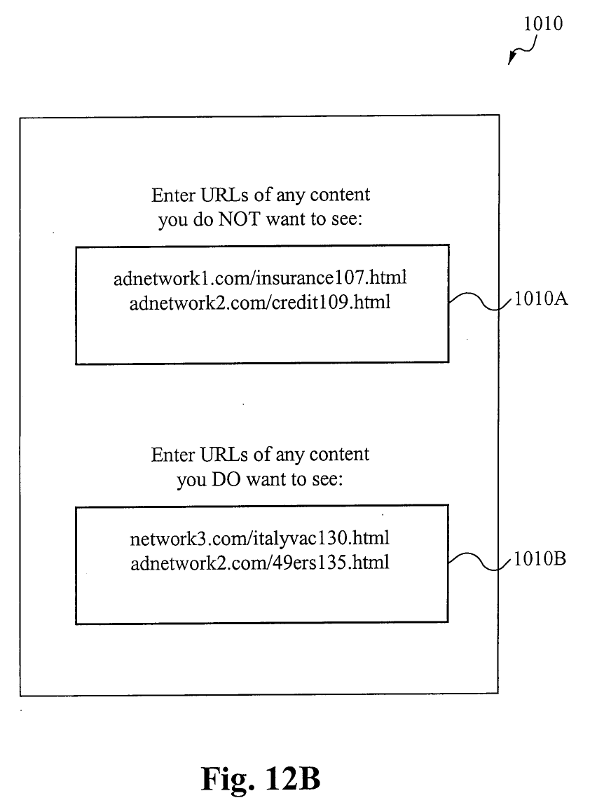

Referring the FIGS. 1, 2 and 11, in operation, a user on the user host 910 registers on the system server 950. The user thus “opts in” to the service, allowing him to substitute content according to the present invention, by sharing his personal or work information with advertisers to receive more ads that he will likely find interesting, and to even get compensated for doing so. The user is now able to download the toolbar 125, which then becomes an extension of the Web browser 911, from the system server 950. The user is also able to set rules for determining what is unwanted content and what is wanted content. He can do this by populating the rules files 400′ and 550 using a user interface, such as shown the graphical user interfaces in FIGS. 12A and 12B. Using the user interface, the user is able to answer questions about himself, such as his age, income, interests, hobbies, upcoming vacation plans, job title, family (number and ages of his children), to name only a few items (FIG. 12A). The user is also able to directly populate rules files by entering URLs of unwanted and wanted content (FIG. 12B) or by setting the path to images and other data on his computer or accessible to his network.

Also, as part of populating rules files, advertisers are able to bid on the price they are willing to pay for users to view their advertisements. Preferably, advertisers post their bids using an interface (not shown) on the system server 950. In this way, in accordance with one embodiment of the present invention, the rules file 760 of FIG. 9 is populated.

Preferably, all the rules files and any configuration files are all downloaded to and stored on the user host 910, allowing the user host 910 to function independently of the system server 950.

Referring to FIGS. 1, 2, 5B, 7, and 11, in operation, the user selects the original content 110 for downloading from the publisher server 940 (e.g., “www.site.com,” FIG. 2) to the user host 910 by clicking on a link to the Web page 100 (the “original Web page”) or by typing in the URL of the original Web page 100. After the original Web page 100 is downloaded to the user host 910, the parser 915A parses the original Web page 100 and identifies the unwanted content 107 and 109 by comparing the original content with entries in the rules file 400′ to find a match. The presentation module 915 then selects wanted content, such as by selecting entries from the rules file 550 using selection criteria, such as discussed above.

Next, the formatter 915B formats the Web page 100 so that the unwanted content will be displayed and the unwanted content will not. In one embodiment, this occurs by embedding in the Web page the URLs for the wanted content (e.g., the URLs in the element 130 and 135), such as found in the rules file 550 of FIG. 7A, and hiding the URLs of unwanted content, thereby generating the updated Web page 120. The Web browser 911 then renders the updated Web page 120, by using the embedded (visible) URLs to fetch the wanted content from the replacement ad server 930.

In one embodiment, the presentation module 915 maintains a history of the sites that a user has visited. URLs to these sites are stored in the rules file 550 or in a separate user profile, indicating that these sites contain wanted content for the user. User profiles are generated on or uploaded to the system server 950. As discussed below, user profiles are used by advertisers or other content providers to contact users about services, products, and the like. The user is able to edit the rules file 550 or his user profile to remove URLs to content that he does not consider wanted. Preferably, the updated rules file 550 is transmitted to the system server 950, replacing the old rules file 550 on the system server 950. In one embodiment, the updated rules file 550 is used to generate a user profile, used to determine wanted and unwanted content for a user such as described below.

In one embodiment, the original Web page 100 requested by the user host 910 is not loaded onto the user host 910. Instead, the Web page 100 is first loaded onto the system server 950, where it is parsed and formatted to generate the updated Web page, which is then downloaded to the user host 910. The system server 950 thus functions as a proxy server.

In this embodiment, the user host 910 is configured so that all HTTP GET requests are automatically routed to the system server 950. The system server 950 requests the original Web page and replaces unwanted content with wanted content in accordance with the present invention to generate an updated Web page. Specifically, the system server 950 parses the original Web page, identifies unwanted content using a first rules file, determines wanted content using a second rules file, and replaces the unwanted content in the Web page with wanted content to generate an updated Web page. The system server 950 then sends the updated Web page to the user host 910.

This embodiment has advantages. For example, executable scripts (e.g., unwanted content) such as Web bugs are not sent to the user host 910. Instead, the scripts are disabled on the system server 950 by “hiding” them so they never execute on the user host 910. Alternatively, the scripts are completely removed from a Web page so that they are never installed on the user host 910. Thus, no executing Web bugs or other surreptitious software is ever installed on the user host 910. The user host 910 thus cannot be monitored for click streams and the like, and is less vulnerable to viruses, Trojan Horse Attacks, and other attacks from malicious software.

In accordance with the present invention, advertisers are able to access user information on the system server 950. Advertisers thus know the identity of the users who view their content, allowing them to contact users and solicit sales, feedback, or other information. In one embodiment, users are able to remain anonymous so that they cannot be directly contacted by advertisers. In this embodiment, though users may remain anonymous, advertisers are still able to collect statistics and other information, such as buying habits, about them.

Preferably, advertisers accessing the system server 950 are able to use a search engine to search for users whose profile matches products sold by the advertisers and who have expressed an interest in being contacted. Advertisers are thus able to search for users based on their personal information (e.g., age and income), work-related information (e.g., job title), or even products that the user has expressed interest in. Furthermore, systems in accordance with the present invention are able to identify real users; accordingly, advertisers are less vulnerable to click fraud.

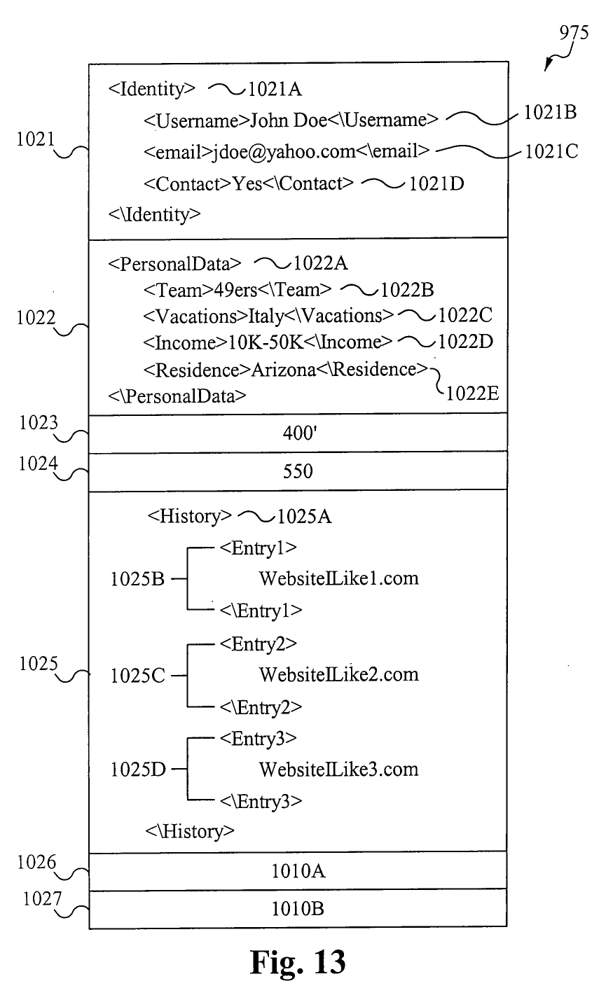

FIG. 13 shows the user profile 975 from FIG. 11. Advertisers use the user profile 975 (1) to determine whether a user is likely to be interested in products and services that the advertiser offers and (2) to contact the user if the user has indicated that he would like to be contacted. The user profile 975 includes a block 1021 that contains an “Identity” element 1021A. The Identity element 1021A includes a “username” element 1021A, an “email” element 1021B, and a “contact” element 1021C. The contact element 1021C contains the data “No” if a user does not want to be contacted by advertisers and “Yes” if he does.

The user profile 975 also includes a block 1022 that includes a “PersonalData” element 1022A, which contains elements that describe all the information that the user entered on the Graphical User Interface 1000 in FIG. 12A: the user's favorite football team (the “Team” element 1022B), the user's vacation plans (the “Vacations” element 1022C), the user's income (the “Income” element 1022D), and the user's state of residence (the “Residence” element 1022E). The user profile 975 also includes a block 1023 containing the file 400′ in FIG. 5B, a block 1024 containing the file 550 in FIG. 7, and a block 1025 containing a “History” element 1025A. Each of the sub-elements 1025B-D in the History element 1025A is a URL of a Web page that the user has visited. These URLs can be used to predict what Web sites contain content that the user considers wanted. Finally, the user profile 975 includes blocks 1026 and 1027 that contain the list of URLs 1010A and 1010B, respectively, that the user submitted in the GUI 1010 in FIG. 12B.

It will be appreciated that the user profile 975 is for illustration only. Those skilled in the art will appreciate that user profiles in accordance with the present invention can have only a subset of the blocks shown in FIG. 13 or more blocks than are shown.

Referring to FIGS. 13 and 11, in operation, an advertiser logs on to the system server 950. The advertiser then searches against the database 970 containing the user profile 975. The advertiser searches the database 970 using search terms to match his product with information in the user profile 975 to determine whether the user would likely want to receive products that the advertiser offers. As one example, the advertiser wishes to determine whether the user would like Super Bowl tickets to a San Francisco 49ers football game. The advertiser thus searches against the database 970 using search terms such as “49ers” and “income over $9,000.” The user profile 975 satisfies this search. The system then checks whether the user has indicated that he would like to be contacted with any promotional materials. Because the user has indicated that he would like to be contacted (element 1021C), the system allows the advertiser to send the user promotional materials that identify the product. The materials can be ads describing the Super Bowl tickets, coupons to the game or nearby hotels, or other types of materials.

When executing a search, an advertiser is able to search using terms such as the name of its product or service, specifications about its product or service, a description of its product or service, and many other types of search terms.

The advertiser is able to send the user promotional materials to the user's email address (element 1021B). Alternatively, the advertiser sends the materials to the user's Internet Protocol (IP) address by embedding the materials as a Web object into a Web page and then transmitting the Web page to the user, in accordance with the present invention. Those skilled in the art will recognize other ways to send users promotional and other materials in accordance with the present invention.

In accordance with other embodiments of the present invention, content in other types of media are replaced. As one example, unwanted content in an Internet television broadcast is identified and replaced with wanted content, such as described above. Unwanted content includes information contained in scroll bars at the bottom of a television broadcast. This information includes advertisements, breaking news stories, and stock tickers, to name a few examples. Other unwanted content is contained in panels or overlays, such as those displaying up-to-the-minute sports scores, local weather, and local traffic reports.

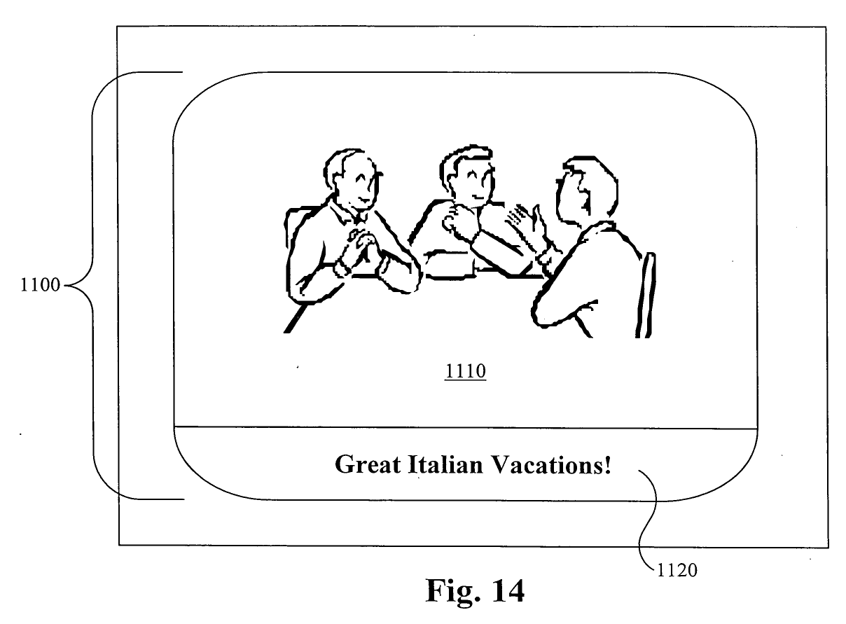

FIG. 14 shows a television broadcast 1100 containing a program 1110 and a scroll bar 1120 after unwanted content has been replaced with wanted content 1120 in accordance with the present invention.

In one example, the Internet television broadcast is transmitted as one or more data packets. The data packets include original (main) program data packets and advertisement data packets that are bundled with the original program data packets or are transmitted separately from the original program data packets. Each data packet has a header that identifies it as either part of the original program or as an advertisement data packet. In one embodiment, the original packet contains data that determines the size and location of the advertisement, as well as the volume (if any) used when presenting the advertisement.

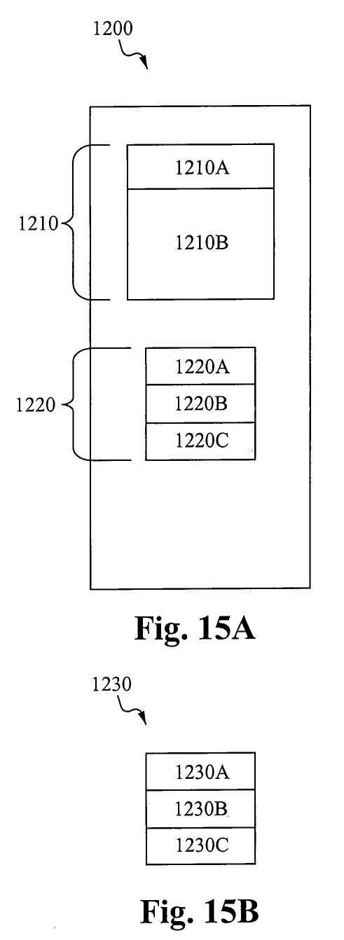

FIG. 15A shows a data packet 1200 containing a sub packet 1210 with original program information 1210 and a sub packet 1220 with advertisement or other possibly unwanted content. The sub packet 1210 contains an identifier 1210A identifying it as original content and a block 1210B containing the actual program data. The sub packet 1220 contains header 1220A that identifies what type of content the packet contains (e.g., an advertisement), a block 1220B that identifies the content (used to determine whether the content is unwanted), and a block 1220C that contains the content or a reference to it.

FIG. 15B shows a sub packet 1230 with wanted content, used to replace the packet 1220 in FIG. 15A. The sub packet 1230 contains header 1230A that identifies what type of content the packet contains (e.g., an advertisement or a user-selected digital image), a block 1230B that identifies the actual content, and a block 1230C that contains the content or a reference to it.

Using the components in FIG. 11 merely as reference, in operation a user on a user host receives a broadcast in one or more data packets (e.g., 1200). The data packets are parsed and unwanted content (e.g., 1220) is identified and replaced with wanted content (e.g., 1230). The broadcast is then played on the user host, such as using a media browser that reads the data packet 1200 and renders the television broadcast with the wanted content instead of the unwanted content.

All or any subset of the components described above in the discussion of Web pages, including rules files, system servers, search engines, parsers, formatters, etc., as shown in FIG. 11 are able to be used with the Internet broadcasts (television, audio, etc.) and other media in which content is replaced in accordance with the present invention. For example, a user host configured to receive television broadcasts is able to be coupled to a system host that stores rules files and information on users, allowing advertisers to match products and services with users, such as described above. On or through the server, advertisers are able to place bids to compensate users who view or listen to the advertisements; users are able to submit their personal and work information; and user profiles are stored, to name a few services. When using interactive television, for example, users are able to use their remote control to submit personal or work information or to identify content (e.g., the commercial currently playing) as wanted or unwanted. This information is able to be stored on the user host and later uploaded to the system host. The server is also able to act as a proxy server and replace unwanted content with wanted content, which it then transmitted to the user host.

In another embodiment, unwanted content in an Internet or other networked audio broadcast is replaced with wanted content. As one example, audio content, such as that rendered using a markup language such as VoiceXML, is replaced. In other embodiments, the audio broadcast is transmitted as data packets, similar to the data packet 1200 in FIG. 15A. In these embodiments, wanted audio (such as audio advertisements) is blended as background to the original audio or inserted into silent portions of an audio broadcast, and played using a voice browser.

In some embodiments, content includes distributed copyrighted material, such as music, play lists, ring tones, and digital rights managements. In one embodiment, the wanted content includes digital photographs and a selectable link that allows a user to immediately order the photographs from a print distributor or other third party.

It will be readily apparent to one skilled in the art that other various modifications may be made to the preferred embodiments without departing from the spirit and scope of the invention as defined by the appended claims.

We claim:

1. A method of replacing content in data distributed over a network comprising:
parsing the data for unwanted content; and
replacing the unwanted content with wanted content.

2. The method of claim 1, wherein the data comprise an Internet television broadcast.

3. The method of claim 2, further comprising playing the Internet television broadcast with the wanted content on a user host.

4. The method of claim 1, wherein the data comprise an Internet audio broadcast.

5. The method of claim 4, further comprising playing the Internet audio broadcast with the wanted content on a user host.

6. The method of claim 1, wherein the data comprise a Web page.

7. The method of claim 6, further comprising displaying the Web page with the wanted content on a user host.

8. The method of claim 1, wherein the unwanted content, the wanted content, or both are determined from user input.

9. The method of claim 8, wherein the user input comprises personal information of the user, work information of the user, or both.

10. The method of claim 1, wherein the wanted content comprises a Web feed, a file, or both.

11. The method of claim 10, wherein the file comprises an image file, an audio file, a video file, an audio-video file, an executable file, or any combination of these.

12. The method of claim 1, wherein the unwanted content comprises a Web feed, a file, or both.

13. The method of claim 12, wherein the file comprises an image file, an audio file, a video file, an audio-video file, an executable file, or any combination of these.

14. The method of claim 1, wherein the data comprise a Web page, the method further comprising providing a toolbar on a Web browser, wherein the toolbar is configured to control replacing the unwanted content with the wanted content in a displayed Web page containing the wanted content.

15. The method of claim 1, wherein the data is parsed on a user host on which the wanted content is presented to a user.

16. The method of claim 1, wherein the data is parsed on a host different from the user host.

17. A method of compensating a user for presenting content on a user host comprising:
replacing unwanted content in data distributed over a network with wanted content based on user-selected information;
presenting the data containing the wanted content on the user host; and
compensating the user based on compensation criteria related to the wanted content.

18. The method of claim 17, wherein the data comprise a Web page, an Internet television broadcast, or an Internet audio broadcast.

19. The method of claim 17, wherein the compensation criteria comprise a bid price associated with the wanted content.

20. The method of claim 17, further comprising providing a toolbar on a Web browser for controlling replacing the unwanted content with the wanted content.

21. The method of claim 17, further comprising collecting the user-selected information.

22. The method of claim 17, wherein the wanted content comprises advertisements.

23. The method of claim 17, wherein the wanted content comprises a Web feed, a file, an identifier for a file, or any combination of these.

24. The method of claim 23, wherein the file is an image file, an audio file, a video file, an audio-video file, or an executable file.

25. The method of claim 17, further comprising registering the user to thereby associate the user with the wanted content.

26. A Web browser comprising a presentation module for controlling replacing unwanted content in a displayed Web page with wanted content based on user-selected information.

27. The Web browser of claim 26, wherein the presentation module comprises a toolbar for controlling replacing the unwanted content with the wanted content.

28. The Web browser of claim 26, wherein the presentation module comprises:
a parser programmed to parse a Web page containing original content and identify unwanted content within the original content; and
a formatter programmed to format the Web page to display the wanted content but not the unwanted content.

29. The Web browser of claim 26, further comprising:
a first rules file for determining unwanted content; and
a second rules file for determining wanted content.

30. The Web browser of claim 26, wherein the Web browser is programmed to communicate with a server, and wherein the server is programmed to format the Web page to display the wanted content but not the unwanted content.

31. The Web browser of claim 30, wherein the server comprises:
a first rules file for determining unwanted content; and
a second rules file for determining wanted content.

32. The Web browser of claim 26, wherein the wanted content comprises a Web feed, a file, an identifier for a file, or any combination of these.

33. The Web browser of claim 32, wherein the identifier comprises a Uniform Resource Locator.

34. The Web browser of claim 32, wherein the file comprises an image file, an audio file, a video file, an audio-video file, or an executable file.

35. A presentation module comprising:
means for identifying unwanted content for presenting with data distributed over a network;
means for associating wanted content for presenting with the data based on user-selected information; and
means for presenting the data with the wanted content in place of the unwanted content.

36. The presentation module of claim 35, wherein the means for associating is programmed to format the data to contain an identifier for accessing the wanted content.

37. The presentation module of claim 36, wherein the identifier comprises a Uniform Resource Locator of the wanted content.

38. The presentation module of claim 35, wherein the data comprise a Web page.

39. The presentation module of claim 35, wherein the data comprise one of an Internet television broadcast and an Internet audio broadcast.

40. The presentation module of claim 39, wherein the presentation module forms part of an electronic device for playing the one of the Internet television broadcast and the Internet audio broadcast.

41. The presentation module of claim 40, wherein the electronic device is a personal computer, a mobile phone, a personal digital assistant or a digital radio.

42. The presentation module of claim 35, wherein the wanted content is a Web feed, a file, an identifier for a file, or any combination of these.

43. The presentation module of claim 42, wherein the identifier comprises a Uniform Resource Locator or a pathname.

44. A system for replacing unwanted content in data distributed over a network with wanted content comprising:
a host programmed to control replacing the unwanted content in the data with the wanted content; and
a server coupled to the host and programmed to determine rules for identifying unwanted content and wanted content and to transmit the rules to the host.

45. The system of claim 44, wherein the host is programmed to display a toolbar for controlling replacing the unwanted content with the wanted content.

46. The system of claim 44, wherein the data comprise a Web page and the toolbar forms part of a Web browser.

47. The system of claim 44, wherein the data comprise an Internet television broadcast or an Internet audio broadcast.

48. The system of claim 44, wherein the host is programmed to replace the unwanted content with the wanted content.

49. The system of claim 44, wherein the server is programmed to replace the unwanted content with the wanted content.

50. A method of matching a user with an item comprising:
storing data generated from user input, wherein the data comprises a record that associates a user with wanted Web content, unwanted Web content, or both; and
matching the record against information corresponding to an item, thereby matching the user with the item.

51. The method of claim 50, further comprising transmitting content identifying the item to an address associated with the user.

52. The method of claim 51, wherein the address is an electronic mail address and the content identifying the item comprises promotional materials for the item.

53. The method of claim 51, wherein the address is an Internet Protocol address and the content identifying the item is a Web object, wherein transmitting the content identifying the item comprises transmitting a Web page containing the Web object to the Internet Protocol address.

54. The method of claim 50, wherein the information corresponding to the item comprises a name of the item, a description of the item, a specification of the item, or any combination of these.

55. The method of claim 50, wherein the user input is personal information supplied by the user, work information supplied by the user, or both.

56. The method of claim 50, wherein the Web content comprises advertisements.

57. The method of claim 50, wherein the data comprises a Uniform Resource Locator.

58. The method of claim 50, wherein the Uniform Resource Locator corresponds to a Web site that the user has visited.

59. A data processing system comprising:
a database storing one or more entries, wherein each entry contains data that is generated from user input and that identifies Web content as either wanted content or unwanted content; and
a search engine for matching the one or more entries against information corresponding to an item, thereby matching a user with the item.

60. The data processing system of claim 58, wherein the item is a product or a service.

61. The data processing system of claim 59, wherein the user input comprises personal information submitted by the user, work information submitted by the user, a Uniform Resource Locator submitted by the user, or any combination of these.

62. The data processing system of claim 59, wherein the Web content comprises an advertisement.
